(19) United States
(12) Patent Application Publication
(10) Pub. No.: US 2023/0383221 A1
(43) Pub. Date: Nov. 30, 2023

(54) Method For Producing Alcohol-containing Food Product

(71) Applicant: Bespoke Ventures Limited, Apia (WS)

(72) Inventors: SHIAN-JUNG CHAO, Shanghai (CN); YUN-SHI CHEN, Shanghai (CN)

(21) Appl. No.: 18/186,226

(22) Filed: Mar. 20, 2023

(30) Foreign Application Priority Data
May 31, 2022 (CN) 2022106156624

(51) Int. Cl. C12G 3/06; A23L 29/256; A23L 29/269; A23L 29/212; A23P 20/10

(52) U.S. Cl. CPC C12G 3/06; A23L 29/256; A23L 29/27; A23L 29/212; A23P 20/10

(57) ABSTRACT

A method for making an alcohol-containing food product comprises combining: (a) a first aqueous solution that includes a multivalent salt, one or more liquid alcohol additives and a thickening agent; with (b) a second aqueous solution that includes an alginate bath. The combination uses extrusion machinery to mass produce spherical beads, less than about 20 mm in typical diameter, with a liquid alcohol center encapsulated in a gelled outer shell. The resulting end product should be collected and stored in a third aqueous solution that maintains similar properties to the first aqueous solution and one or more liquid alcohol additives.

### CROSS-REFERENCE TO RELATED APPLICATIONS

This application claims priority of China Patent Application No. 2022106156624, filed on May 31, 2022, the content of which is incorporated herein in its entirety by reference.

### BACKGROUND OF THE INVENTION

This disclosure relates to a method for massively producing an alcohol-containing food product with an edible gelled outer shell and a flavored liquid interior. In particular, it can be stored and used as needed.

The common alcoholic snacks include liquor-filled chocolate or wine jelly. The former involves wrapping spirits such as vodka, whisky, brandy, and rum in high-concentration chocolate, allowing consumers to enjoy the rich chocolate and spicy and strong alcohol at the same time. Wine jelly, on the other hand, is typically made into colorful cocktail jelly forms and has a special visual impact.

However, these types of products are more suitable for individual consumption and are not designed to be added to beverages such as tea. If placed in tea, the hard texture will produce an inconsistent chewing sensation. Therefore, alcohol beverages are generally added directly to tea. Although consumers can taste the aroma of both the alcohol and the tea at the same time, the taste may be slightly weak.

Therefore, how to combine alcohol beverages with tea while improving the taste is an important issue that those in the relevant technical field wants to solve.

### SUMMARY OF THE INVENTION

This disclosure provides a method for massively producing an alcohol-containing food product with an edible gelled outer shell and a flavored liquid interior. The method includes the following steps: (a) prepare a first aqueous solution including a first alcohol solution, a solvent, a syrup, a food additive, a food flavor, a preservative and a thickening agent, wherein a pH value of the first aqueous solution is 5 to 7; (b) stir the first aqueous solution at a constant speed and maintain a temperature of the first aqueous solution at 8-25° C., wherein the constant speed is no more than 100 RPM; (c) sterilize the first aqueous solution with water bath; (d) prepare a second aqueous solution including an alginate, wherein a pH value of the second aqueous solution is 5 to 7; (e) form first spherical beads of a non-gelled liquid alcohol encapsulated in the edible gelled outer shell by quantitatively dripping the first aqueous solution into the second aqueous solution; (f) sort second spherical beads with a size from the first spherical beads by a screen; (g) set the second spherical beads by heating up the second spherical beads under 70 to 90° C. for 5 to 15 minutes; and (h) store the set second spherical beads in a third aqueous solution, wherein the third aqueous solution comprising a second alcohol solution, and wherein an alcohol concentration of the first aqueous solution or the second aqueous solution is 5 to 7 v/v %, and a pH value of the third aqueous solution is 5 to 7.

The method is meant to produce alcohol-containing food products with high quality stably, constantly, and massively. By following the method, the alcohol-containing food products may maintain the size and last at least 250 days under moderate temperature.

The alcohol-containing food products are invented to enhance the taste of a drink or food. They will pop and burst out with flavored liquid when bitten. The alcohol may be neutral spirits, ethyl alcohol, wine, sherry, brandy, liqueur, port, vodka, gin, whisky, scotch, cognac, tequila, rum, champagne and combinations thereof. By adding the alcohol-containing food products to a drink or food, it will increase the flavor and layer of the drink or food.

The thickness of the edible gelled outer shell may be made different depends on the temperature of the drink. When the drink is below 4° C., the thickness of the edible gelled outer shell may be thinner than the one under room temperature. On the other hand, when the drink is above 45° C., the thickness of the edible gelled outer shell may be thicker than the one under room temperature.

In addition to water bath, the sterilizing method may be steaming, pickling, chlorine disinfection, antisepsis, or other food sterilization methods.

The set second spherical beads are stored in the third aqueous solution, which acts as a preservation liquid for the set second spherical beads, together as an alcohol-containing food product, and put into a tin plate for storage or further packaged and shipped to other places.

In one embodiment, the alcohol concentration of the first aqueous solution or the second aqueous solution is 5 to 7 v/v %, and a pH value of the third aqueous solution is 5 to 7. In another embodiment, the alcohol concentration of the first aqueous solution or the second aqueous solution is 5.5 to 7 v/v %, 6 to 7 v/v %, 6.5 to 7 v/v %, 5 to 6.5 v/v %, 5 to 6 v/v % or 5 to 5.5 v/v %. In a preferable embodiment, the alcohol concentration of the first aqueous solution or the second aqueous solution is 5 v/v %, 5.5 v/v %, 6 v/v %, 6.5 v/v % or 7 v/v %.

In one embodiment, the solvent is water.

In one embodiment, the syrup includes fructose syrup or glucose syrup.

In one embodiment, the food additive includes hydroxypropyl distarch phosphate, sodium alginate, lactic acid, potassium sorbate, or any combination thereof.

In one embodiment, the food flavor includes coffee concentrate, juice concentrate, soda concentrate, turmeric concentrate and any combinations thereof.

In one embodiment, the constant speed is 80 to 100 RPM. In another embodiment, the constant speed is 85 to 100 RPM, 90 to 100 RPM, 95 to 100 RPM, 80 to 95 RPM, 80 to 90 RPM, or 80 to 85 RPM. In a preferable embodiment, the constant speed is 80 RPM, 85 RPM, 90 RPM, 95 RPM, or 100 RPM.

In one embodiment, the first aqueous solution comprises multivalent salt.

In one embodiment, the multivalent salt is selected from the group consisting of calcium chloride, calcium lactate, calcium lactate gluconate, magnesium chloride, manganese chloride and combinations thereof.

In one embodiment, the size of the first spherical beads and second spherical beads are 9 to 13 mm. In another embodiment, the size of the first spherical beads and second spherical beads are 10 to 13 mm, 11 to 13, 12 to 13 mm, 9 to 12 mm, 9 to 11 mm, 9 to 10 mm. In a preferable embodiment, the size of the first spherical beads and second spherical beads are 9 mm, 10 mm, 11 mm, 12 mm, or 13 mm.

In one embodiment, Step (f) further comprises excluding shriveled, unrounded spherical beads from the second spherical beads.

In one embodiment, the heating temperature is 80° C. in Step (g).

In one embodiment, the heating time in Step (g) is 10 to 20 minutes. In another embodiment, the heating time in Step (g) is 12 to 20 minutes, 14 to 20 minutes, 16 to 20 minutes, 18 to 20 minutes, 10 to 18 minutes, 10 to 16 minutes, 10 to 14 minutes, or 10 to 12 minutes. In a preferable embodiment, the heating time in Step (g) is 10 minutes, 11 minutes, 12 minutes, 13 minutes, 14 minutes, 15 minutes, 16 minutes, 17 minutes, 18 minutes, 19 minutes, or 20 minutes.

In one embodiment, the first alcohol solution and second alcohol solution are same.

In one embodiment, the first alcohol solution and second alcohol solution are different.

In one embodiment, the first aqueous solution contains about 1 to 10 wt. % of the multivalent salt. In another embodiment, the first aqueous solution contains about 1 to 9 wt. %, 2 to 9 wt. %, 3 to 9 wt. %, 4 to 9 wt. %, 5 to 9 wt. %, 6 to 9 wt. %, 7 to 9 wt. %, 8 to 9 wt. %, 1 to 8 wt. %, 1 to 7 wt. %, 1 to 6 wt. %, 1 to 5 wt. %, 1 to 4 wt. %, 1 to 3 wt. %, or 1 to 2 wt. % of the multivalent salt. In a preferable embodiment, the first aqueous solution contains about 1 wt. %, 2 wt. %, 3 wt. %, 4 wt. %, 5 wt. %, 6 wt. %, 7 wt. %, 8 wt. %, 9 wt. %, or 10 wt. % of the multivalent salt.

In one embodiment, the thickening agent includes a polysaccharide.

In one embodiment, the polysaccharide is selected from the group consisting of xanthan gum, starch, and combinations thereof.

In one embodiment, the first aqueous solution contains about 2 to 40% alcohol by volume resulting from a liquid alcohol additive selected from the group consisting of neutral spirits, ethyl alcohol, wine, sherry, brandy, liqueur, port, vodka, gin, whisky, scotch, cognac, tequila, rum, champagne and combinations thereof. In another embodiment, the first aqueous solution contains about 7 to 40%, 12 to 40%, 17 to 40%, 22 to 40%, 27 to 40%, 32 to 40%, 37 to 40%, 2 to 35%, 2 to 30%, 2 to 25%, 2 to 20%, 2 to 15%, 2 to 10%, 2 to 10%, or 2 to 5% alcohol by volume resulting from a liquid alcohol additive selected from the group consisting of neutral spirits, ethyl alcohol, wine, sherry, brandy, liqueur, port, vodka, gin, whisky, scotch, cognac, tequila, rum, champagne and combinations thereof. In a preferable embodiment, the first aqueous solution contains about 2 to 7%, 2 to 12%, 2 to 17%, 2 to 22%, 2 to 27%, 2 to 32%, or 2 to 37% alcohol by volume resulting from a liquid alcohol additive selected from the group consisting of neutral spirits, ethyl alcohol, wine, sherry, brandy, liqueur, port, vodka, gin, whisky, scotch, cognac, tequila, rum, champagne and combinations thereof.

In one embodiment, the second aqueous solution contains between about 2 to 40% alcohol by volume resulting from a liquid alcohol additive selected from the group consisting of neutral spirits, ethyl alcohol, wine, sherry, brandy, liqueur, port, vodka, gin, whisky, scotch, cognac, tequila, rum, champagne and combinations thereof. In another embodiment, the second aqueous solution contains about 7 to 40%, 12 to 40%, 17 to 40%, 22 to 40%, 27 to 40%, 32 to 40%, 37 to 40%, 2 to 35%, 2 to 30%, 2 to 25%, 2 to 20%, 2 to 15%, 2 to 10%, 2 to 10%, or 2 to 5% alcohol by volume resulting from a liquid alcohol additive selected from the group consisting of neutral spirits, ethyl alcohol, wine, sherry, brandy, liqueur, port, vodka, gin, whisky, scotch, cognac, tequila, rum, champagne and combinations thereof. In a preferable embodiment, the second aqueous solution contains about 2 to 7%, 2 to 12%, 2 to 17%, 2 to 22%, 2 to 27%, 2 to 32%, or 2 to 37% alcohol by volume resulting from a liquid alcohol additive selected from the group consisting of neutral spirits, ethyl alcohol, wine, sherry, brandy, liqueur, port, vodka, gin, whisky, scotch, cognac, tequila, rum, champagne and combinations thereof.

In one embodiment, the third aqueous solution contains between about 2 to 40% alcohol by volume resulting from a liquid alcohol additive selected from the group consisting of neutral spirits, ethyl alcohol, wine, sherry, brandy, liqueur, port, vodka, gin, whisky, scotch, cognac, tequila, rum, champagne and combinations thereof. In another embodiment, the third aqueous solution contains about 7 to 40%, 12 to 40%, 17 to 40%, 22 to 40%, 27 to 40%, 32 to 40 %, 37 to 40%, 2 to 35%, 2 to 30%, 2 to 25%, 2 to 20%, 2 to 15%, 2 to 10%, 2 to 10%, or 2 to 5% alcohol by volume resulting from a liquid alcohol additive selected from the group consisting of neutral spirits, ethyl alcohol, wine, sherry, brandy, liqueur, port, vodka, gin, whisky, scotch, cognac, tequila, rum, champagne and combinations thereof. In a preferable embodiment, the third aqueous solution contains about 2 to 7%, 2 to 12%, 2 to 17%, 2 to 22%, 2 to 27%, 2 to 32%, or 2 to 37% alcohol by volume resulting from a liquid alcohol additive selected from the group consisting of neutral spirits, ethyl alcohol, wine, sherry, brandy, liqueur, port, vodka, gin, whisky, scotch, cognac, tequila, rum, champagne and combinations thereof.

In one embodiment, the set second spherical beads can maintain the size for at least 250 days.

In one embodiment, a thickness of the edible gelled outer shell is 0.1 to 0.2 mm.

In one embodiment, the set second spherical beads can maintain its elasticity under 4 to 10° C.

In one embodiment, Step (f) further comprises using a first mesh to collect a mid-product and using a second mesh to collect the second spherical beads from the mid-product.

In one embodiment, a diameter of the mid-product is above 8.5 mm, and a diameter of the second spherical beads is 8.5 to 10.5 mm. In another embodiment, a diameter of the mid-product is above 8.5 mm, and a diameter of the second spherical beads is 9 to 10.5 mm, 9.5 to 10.5 mm, 10 to 10.5 mm, 8.5 to 10 mm, 8.5 to 9.5 mm, or 8.5 to 9 mm. In a preferable embodiment, a diameter of the mid-product is above 8.5mm, and a diameter of the second spherical beads is 8.5 mm, 9 mm, 9.5 mm, 10 mm, or 10.5 mm.

This disclosure provides another method for massively producing an alcohol-containing food product with an edible gelled outer shell and a flavored liquid interior. The method includes the following steps: (a) prepare a first aqueous solution including a first alcohol solution, a solvent, a syrup, a multivalent salt, a food additive, a food flavor, a preservative and a thickening agent, wherein a pH value of the first aqueous solution is 2 to 7; (b) stir the first aqueous solution at a constant speed and maintain a temperature of the first aqueous solution at 8 to 25° C., wherein the constant speed is 80 to 100 RPM; (c) sterilize the first aqueous solution with hot water circulation; (d) prepare a second aqueous solution including an alginate, wherein a pH value of the second aqueous solution is 5 to 7; (e) form first spherical beads of a non-gelled liquid alcohol encapsulated in the edible gelled outer shell by quantitatively dripping the first aqueous solution into the second aqueous solution; (f) sort second spherical beads with a size from the first spherical beads by at least two screens; (g) exclude shriveled, unrounded spherical beads from the second spherical beads; (h) set the second spherical beads by heating up the second spherical beads under 70 to 90° C. for 5 to 15 minutes; and (i) storing the set second spherical beads in a third aqueous solution, wherein the third aqueous solution comprising a second alcohol solution, and wherein an alcohol concentration of the first aqueous solution or the second aqueous solution is 5 to 7 v/v %, and a pH value of the third aqueous solution is 5 to 7; wherein the set second spherical beads can maintain its elasticity under 4 to 10° C.

### BRIEF DESCRIPTION OF DRAWINGS

FIG. 1 is a flow chart illustrating the manufacturing process of the alcohol-containing food product of an embodiment of the present disclosure.

FIGS. 2A to 2C are another flow charts illustrating the manufacturing process of the alcohol-containing food product of an embodiment of the present disclosure.

FIG. 3 is an illustration of a second aqueous solution of the alcohol-containing food product.

FIG. 4 is an illustration of an alcohol-containing food product.

### DETAILED DESCRIPTION OF THE INVENTION

The main purpose of the present disclosure is to provide a method for massively producing an alcohol-containing food product with an edible gelled outer shell and a flavored liquid interior. By using a special coating technique to spherify a second aqueous solution and encapsulate a first aqueous solution, the alcohol-containing food product can not only have a unique texture, but also have an alcoholic flavor that complements the first aqueous solution. When combined with tea, it can enhance a special subtle drunkenness flavor and the complex of a taste.

Another purpose of the present disclosure is to provide a method for massively producing an alcohol-containing food product with an edible gelled outer shell and a flavored liquid interior, which can immerse flavor liquids such as alcohol into the outer shell and the first aqueous solution inside the flavored liquid interior by means of immersion after a formation of the alcohol-containing food product, so that the alcohol concentration of the first aqueous solution inside the alcohol-containing food product can be increased, without affecting the formation and taste of the outer shell.

To achieve the above purpose, the present disclosure provides a method for massively producing an alcohol-containing food product with an edible gelled outer shell and a flavored liquid interior. Firstly, a first aqueous solution mixed with calcium ion compound is provided. Next, a second aqueous solution is mixed with an alginate, so that the calcium ion compound in the second aqueous solution reacts with the alginate to form an outer shell that encloses the first aqueous solution. Then, the first aqueous solution with the outer shell is immersed in a third aqueous solution, allowing the third aqueous solution to penetrate into the outer shell and the first aqueous solution, resulting in an alcohol-containing food product with a unique texture.

The embodiments of the present disclosure will be further explained with reference to the following figures. As much as possible, the same symbols in the figures and the specification represent the same or similar components. In the drawings, the shapes and thicknesses may be exaggerated for simplification and convenience of illustration. It is to be understood that the components not specifically shown in the drawings or described in the specification are known to those skilled in the art of the relevant technology. Those skilled in the art of this field may make various changes and modifications based on the content of the present invention.

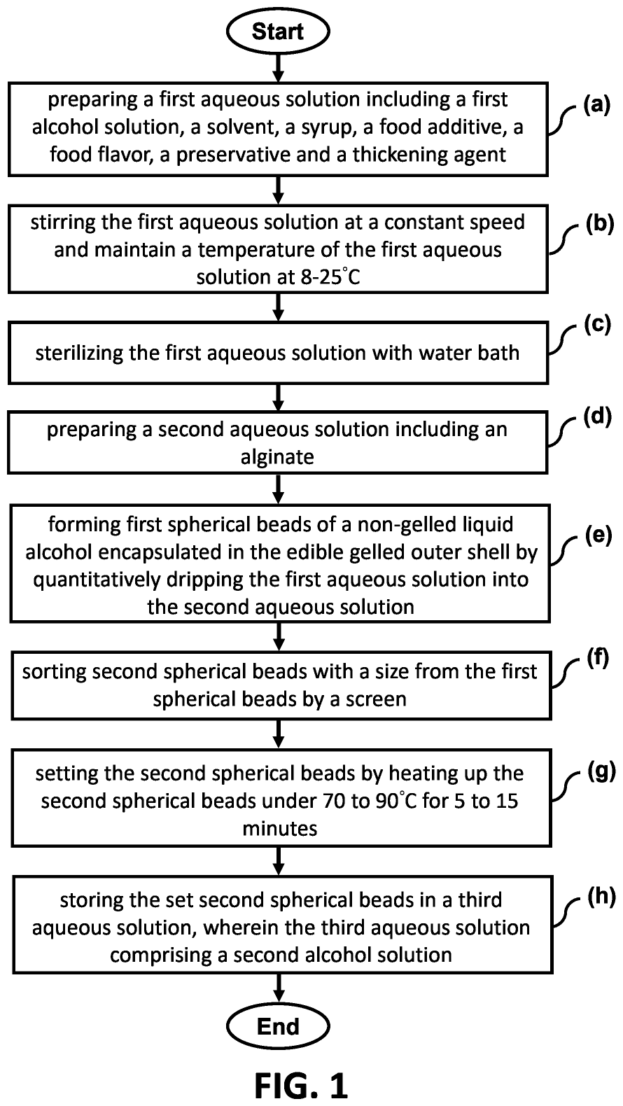

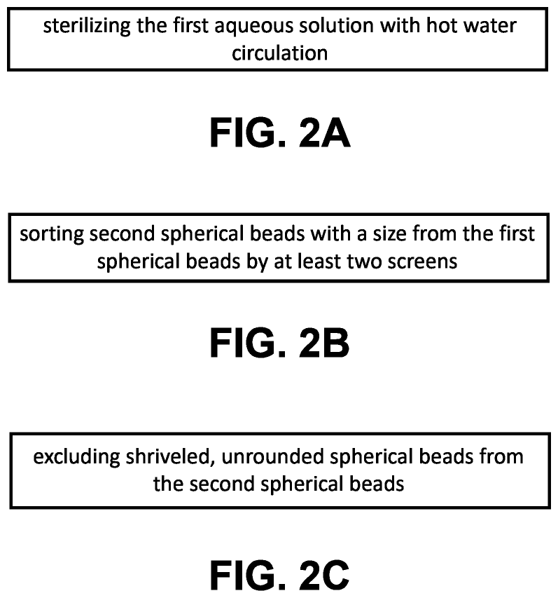

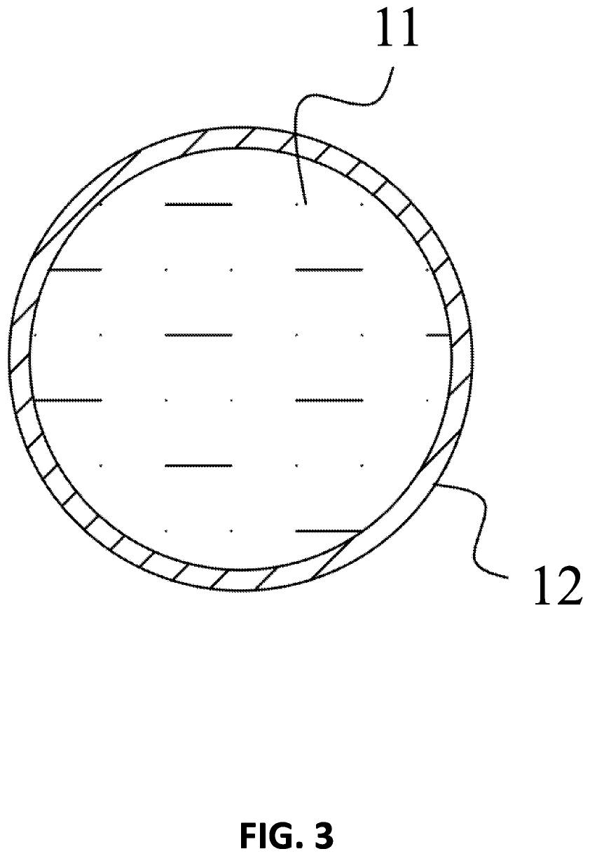

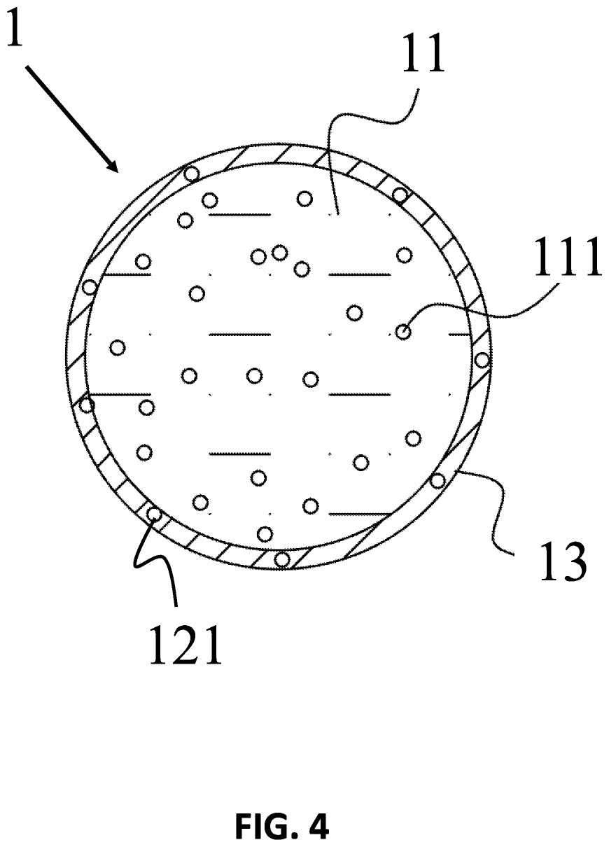

FIG. 1 is a flow chart illustrating the manufacturing process of the alcohol-containing food product of an embodiment of the present disclosure. FIG. 2 is another flow chart illustrating the manufacturing process of the alcohol-containing food product of an embodiment of the present disclosure. FIG. 3 is an illustration of a second aqueous solution of the alcohol-containing food product. FIG. 4 is an illustration of an alcohol-containing food product.

Please refer to FIG. 1. The flow chart illustrates a general step of massively producing an alcohol-containing food product with an edible gelled outer shell and a flavored liquid interior. First (Step (a)), prepare a first aqueous solution including a first alcohol solution, a solvent, a syrup, a food additive, a food flavor, a preservative and a thickening agent. The pH value of the first aqueous solution is 5 to 7. Besides, the solvent can be water, which can adjust the concentration of the syrup, the food additive, the food flavor, the preservative, and the thickening agent. Moreover, the syrup can be a fructose syrup or a glucose syrup, the food additive can be a hydroxypropyl distarch phosphate, sodium alginate, lactic acid, potassium sorbate, or any combination thereof, and the food flavor can be a coffee concentrate, juice concentrate, soda concentrate, turmeric concentrate and any combinations thereof.

Second (Step (b)), stir the first aqueous solution at a constant speed and maintain a temperature of the first aqueous solution at 8-25° C. The constant speed is no more than 100 RPM. It is preferred that the constant speed is 80 to 100 RPM in general. By maintaining the speed, the first aqueous solution can maintain in an ideal condition. Besides, the first aqueous solution includes a multivalent salt, and the multivalent salt is selected from the group consisting of calcium chloride, calcium lactate, calcium lactate gluconate, magnesium chloride, manganese chloride and combinations thereof. The main function of multivalent salt in beverages is to add minerals, and it can also adjust the taste of the beverage. Many people like to add multivalent salt to their drinks, such as sea salt, rock salt, or Himalayan salt, which contain various minerals that can provide nutrition to the body and enhance the flavor and texture of the beverage. In addition, multivalent salt can also adjust the taste of the beverage, making it richer and more complex. For example, adding a little rock salt to lemon water can neutralize the acidity of the lemon and make the taste milder. Adding a little Himalayan salt to fruit juice can enhance the freshness of the juice and make the taste more delicious. It is important to control the amount of multivalent salt added to beverages and avoid overconsumption. That is, it is recommended to choose the appropriate type of multivalent salt based on personal taste and needs. In general, 1 to 10 wt. % of the multivalent salt is recommended.

Third (Step (c)), sterilize the first aqueous solution with water bath. Water bath includes circulating water baths, non-circulating water baths, and shaking water baths. In another embodiment, please refer to FIG. 2A, it is preferred to use hot water circulation water bath to sterilize the first aqueous solution.

Fourth (Step (d)), prepare a second aqueous solution including an alginate. The pH value of the second aqueous solution is 5 to 7. The alginate is used to facilitate the second aqueous solution to encapsulate the first aqueous solution. Further, the first alcohol solution and the second alcohol solution can be the same or different. If the first alcohol solution and the second alcohol solution are the same, the flavor of the alcohol-containing food product is enhanced. If the first alcohol solution and the second alcohol solution are different, the flavor of the alcohol-containing food product is rich and surprising. Further, the thickening agent includes a polysaccharide, which is selected from the group consisting of xanthan gum, starch, and combinations thereof. By adding the thickening agent, it may increase the complex of the taste of the alcohol-containing food product.

Fifth (Step (e)), form first spherical beads of a non-gelled liquid alcohol encapsulated in the edible gelled outer shell by quantitatively dripping the first aqueous solution into the second aqueous solution. The edible gelled outer shell is made from the second aqueous solution. The amount of every drop of the first aqueous solution is well-controlled to conform to a predetermined condition.

Sixth (Step (f)), sort second spherical beads with a size from the first spherical beads by a screen. If the size is too big or too small, it will affect the taste of the alcohol-containing food product. Thus, the size of the first spherical beads and second spherical beads are preferred to be 9 to 13 mm. Besides, this step further includes using a first mesh to collect a mid-product, and using a second mesh to collect the second spherical beads from the mid-product. A diameter of the mid-product is above 8.5 mm, and a diameter of the second spherical beads is 8.5 to 10.5 mm. The diameter of the second spherical beads is designed to best fit the mouth size of the average consumer. Moreover, in another embodiment, please refer to FIG. 2B, it is preferred to sort second spherical beads with a size from the first spherical beads by at least two screens in order to sort out the ideal second spherical beads. Next, please refer to FIG. 2C, it is preferred to exclude shriveled, unrounded spherical beads from the second spherical beads. By doing so, the appearance quality of the second spherical beads can be maintained.

Seventh (Step (g)), set the second spherical beads by heating up the second spherical beads under 70 to 90° C. for 5 to 15 minutes. In one embodiment, it is preferred to heat up the second spherical beads under 80° C. for 10 to 20 minutes.

Eighth (Step (h)), store the set second spherical beads in a third aqueous solution. The third aqueous solution includes a second alcohol solution. Further, an alcohol concentration of the first aqueous solution or the second aqueous solution is 5 to 7 v/v %, and a pH value of the third aqueous solution is 5 to 7. Further, the first aqueous solution, second aqueous solution, or third aqueous solution contain about 2 to 40% alcohol by volume resulting from a liquid alcohol additive selected from the group consisting of neutral spirits, ethyl alcohol, wine, sherry, brandy, liqueur, port, vodka, gin, whisky, scotch, cognac, tequila, rum, champagne and combinations thereof. When placing the alcohol-containing food products into a cup of tea or juice, the richness and complex of the taste will be increased when biting them. Moreover, the set second spherical beads can maintain the size for at least 250 to 300 days and their elasticity under 4 to Compared to the prior arts, none of them could provide such a long preservation period while maintaining its elasticity. Further, the thickness of the edible gelled outer shell is 0.1 to 0.2 mm. The thickness of the edible gelled outer shell plays an important role of maintaining the size and elasticity of the set second spherical beads. Therefore, our method not only can maintain elasticity and prevent easy breakage, but also can transport the product in tin cans to remote areas while maintaining consistent quality and taste. As a result, our production costs can be significantly reduced due to centralized production.

Please refer to FIG. 3. The figure illustrates an embodiment of a second aqueous solution 12 of the alcohol-containing food product, which forms an edible gelled outer shell of the alcohol-containing food product after the first aqueous solution 11 is quantitively dripped into it. The second aqueous solution 12 includes an alginate and the pH value of the second aqueous solution 12 is 5 to 7. Further, the second aqueous solution 12 can contain between about 2 to 40% alcohol by volume resulting from a liquid alcohol additive selected from the group consisting of neutral spirits, ethyl alcohol, wine, sherry, brandy, liqueur, port, vodka, gin, whisky, scotch, cognac, tequila, rum, champagne and combinations thereof. On the other hand, the second aqueous solution 12 can be colorless and odorless.

Please refer to FIG. 4. The figure illustrates an embodiment of a second spherical bead 1 of the alcohol-containing food product. The second spherical bead 1 includes the first aqueous solution 11 and the second aqueous solution, wherein the second aqueous solution is formed into an edible gelled outer shell 13. Further, it is worth knowing that the first aqueous solution 11, also known as a flavored liquid interior, may partially infiltrate into the second aqueous solution. Moreover, the first aqueous solution 11 includes a liquid alcohol additive 111, and the second aqueous solution includes an alginate 121.

### BRIEF DESCRIPTION OF SYMBOLS

Steps (a)˜(h)

Second spherical bead 1

First aqueous solution 11

Liquid alcohol additive 111

Second aqueous solution 12

Edible gelled outer shell 13

Alginate 121

1. A method for massively producing an alcohol-containing food product with an edible gelled outer shell and a flavored liquid interior, comprising:
(a) preparing a first aqueous solution including a first alcohol solution, a solvent, a syrup, a food additive, a food flavor, a preservative and a thickening agent, wherein a pH value of the first aqueous solution is 5 to 7;
(b) stirring the first aqueous solution at a constant speed and maintain a temperature of the first aqueous solution at 8-25° C., wherein the constant speed is no more than 100 RPM;
(c) sterilizing the first aqueous solution with water bath;
(d) preparing a second aqueous solution including an alginate, wherein a pH value of the second aqueous solution is 5 to 7;
(e) forming first spherical beads of a non-gelled liquid alcohol encapsulated in the edible gelled outer shell by quantitatively dripping the first aqueous solution into the second aqueous solution;
(f) sorting second spherical beads with a size from the first spherical beads by a screen;
(g) setting the second spherical beads by heating up the second spherical beads under 70 to for 5 to 15 minutes; and
(h) storing the set second spherical beads in a third aqueous solution, wherein the third aqueous solution comprising a second alcohol solution, and wherein an alcohol concentration of the first aqueous solution or the second aqueous solution is 5 to 7 v/v %, and a pH value of the third aqueous solution is 5 to 7.

2. The method of claim 1, wherein the solvent is water.

3. The method of claim 1, wherein the syrup including fructose syrup or glucose syrup.

4. The method of claim 1, wherein the food additive including hydroxypropyl distarch phosphate, sodium alginate, lactic acid, potassium sorbate, or any combinations thereof. The method of claim 1, wherein the food flavor including coffee concentrate, juice concentrate, soda concentrate, turmeric concentrate and any combinations thereof.

6. The method of claim 1, wherein the constant speed is 80 to 100 RPM.

7. The method of claim 1, wherein the first aqueous solution further comprises a multivalent salt.

8. The method of claim 7, wherein the multivalent salt is selected from the group consisting of calcium chloride, calcium lactate, calcium lactate gluconate, magnesium chloride, manganese chloride and combinations thereof.

9. The method of claim 1, wherein the size of the first spherical beads and second spherical beads are 9 to 13 mm.

10. The method of claim 1, wherein Step (f) further comprises excluding shriveled, unrounded spherical beads from the second spherical beads.

11. The method of claim 1, wherein a heating temperature is 80° C. in Step (g).

12. The method of claim 1, wherein the heating time in Step (g) is 10 to 20 minutes.

13. The method of claim 1, wherein the first alcohol solution and second alcohol solution are same.

14. The method of claim 1, wherein the first alcohol solution and second alcohol solution are different.

15. The method of claim 1, wherein the first aqueous solution contains about 1 to 10 wt. % of the multivalent salt.

16. The method of claim 1, wherein the thickening agent includes a polysaccharide.

17. The method of claim 7, wherein the polysaccharide is selected from the group consisting of xanthan gum, starch, and combinations thereof.

18. The method of claim 1, wherein the first aqueous solution contains between about 2 to 40% alcohol by volume resulting from a liquid alcohol additive selected from the group consisting of neutral spirits, ethyl alcohol, wine, sherry, brandy, liqueur, port, vodka, gin, whisky, scotch, cognac, tequila, rum, champagne and combinations thereof.

19. The method of claim 1, wherein the second aqueous solution contains between about 2 to 40% alcohol by volume resulting from a liquid alcohol additive selected from the group consisting of neutral spirits, ethyl alcohol, wine, sherry, brandy, liqueur, port, vodka, gin, whisky, scotch, cognac, tequila, rum, champagne and combinations thereof.

20. The method of claim 1, wherein the third aqueous solution contains between about 2 to 40% alcohol by volume resulting from a liquid alcohol additive selected from the group consisting of neutral spirits, ethyl alcohol, wine, sherry, brandy, liqueur, port, vodka, gin, whisky, scotch, cognac, tequila, rum, champagne and combinations thereof.

21. The method of claim 1, wherein the set second spherical beads can maintain the size for at least 250 days.

22. The method of claim 1, a thickness of the edible gelled outer shell is 0.1 to 0.2 mm.

23. The method of claim 1, wherein the set second spherical beads can maintain their elasticity under 4 to 10° C.

24. The method of claim 1, wherein Step(f) further comprises using a first mesh to collect a mid-product, and using a second mesh to collect the second spherical beads from the mid-product.

25. The method of claim 24, wherein a diameter of the mid-product is above 8.5 mm, and a diameter of the second spherical beads is 8.5 to 10.5 mm.

26. A method for massively producing an alcohol-containing food product with an edible gelled outer shell and a flavored liquid interior, comprising:
(a) preparing a first aqueous solution including a first alcohol solution, a solvent, a syrup, a multivalent salt, a food additive, a food flavor, a preservative and a thickening agent, wherein a pH value of the first aqueous solution is 2 to 7;
(b) stirring the first aqueous solution at a constant speed and maintain a temperature of the first aqueous solution at 8 to 25° C., wherein the constant speed is 80 to 100 RPM;
(c) sterilizing the first aqueous solution with hot water circulation;
(d) preparing a second aqueous solution including an alginate, wherein a pH value of the second aqueous solution is 5 to 7;
(e) forming first spherical beads of a non-gelled liquid alcohol encapsulated in the edible gelled outer shell by quantitatively dripping the first aqueous solution into the second aqueous solution;
(f) sorting second spherical beads with a size from the first spherical beads by at least two screens;
(g) excluding shriveled, unrounded spherical beads from the second spherical beads;
(h) setting the second spherical beads by heating up the second spherical beads under 70 to for 5 to 15 minutes; and
(i) storing the set second spherical beads in a third aqueous solution, wherein the third aqueous solution comprising a second alcohol solution, and
wherein an alcohol concentration of the first aqueous solution or the second aqueous solution is 5 to 7 v/v %, and a pH value of the third aqueous solution is 5 to 7;
wherein the set second spherical beads can maintain its elasticity under 4 to 10° C.
